(19) United States
(12) Patent Application Publication
(10) Pub. No.: US 2007/0147610 A1
(43) Pub. Date: Jun. 28, 2007

(54) Methods and Systems for Providing Authenticated Digital Information

(76) Inventor: Amarender Reddy Kethi Reddy, Corona, CA (US)

Correspondence Address: KRIEGER INTELLECTUAL PROPERTY, INC., P.O. BOX 1073, CAMAS, WA, 98607, US

(21) Appl. No.: 11/684,738

(22) Filed: Mar. 12, 2007

Related U.S. Application Data
(63) Continuation-in-part of application No. 11/192,615, filed on Jul. 29, 2005.
(63) Continuation-in-part of application No. 11/241,320, filed on Sep. 30, 2005.
(63) Continuation-in-part of application No. 11/255,333, filed on Oct. 21, 2005.
(63) Continuation-in-part of application No. 11/256,493, filed on Oct. 21, 2005.
(63) Continuation-in-part of application No. 11/073,055, filed on Mar. 4, 2005.

(51) Int. Cl. H04N 7/167

(52) U.S. Cl. 380/229

(57) ABSTRACT

Embodiments of the present invention comprise systems, methods and devices for providing digital data authentication at an imaging device.

### RELATED REFERENCES

This application is a continuation-in-part of U.S. patent application Ser. No. 11/192,615, entitled “Methods and Systems for Providing Remote File Structure Access on an Imaging Device,” filed on Jul. 29, 2005; this application is also a continuation-in-part of U.S. patent application Ser. No. 11/241,320, entitled “Methods and Systems for Accessing Remote, Descriptor-Related Data at an Imaging Device,” filed on Sep. 30, 2005; this application is also a continuation-in-part of U.S. patent application Ser. No. 11/255,333, entitled “Methods and Systems for Imaging Device Metadata Management,” filed on Oct. 21, 2005; this application is also a continuation-in-part of U.S. patent application Ser. No. 11/256,493, entitled “Methods and System for Imaging Device Document Modification,” filed on Oct. 21, 2005; and this application is also a continuation-in-part of U.S. patent application Ser. No. 11/073,055, entitled “Methods and Systems for Peripheral Accounting,” filed on Mar. 4, 2005. U.S. patent application Ser. No. 11/192,615 is hereby incorporated by reference herein. U.S. patent application Ser. No. 11/241,320 is hereby incorporated by reference herein. U.S. patent application Ser. No. 11/255,333 is hereby incorporated by reference herein. U.S. patent application Ser. No. 11/256,493 is hereby incorporated by reference herein. U.S. patent application Ser. No. 11/073,055 is hereby incorporated by reference herein.

### BACKGROUND OF THE INVENTION

Imaging devices such as printers, copiers, scanners and fax machines may have a wide array of functions and capabilities to fit specific uses or combinations of uses. Imaging devices may take the form of a multi-function peripheral (MFP) device that combines the functions of two or more of the traditionally separated imaging devices. An MFP may combine any number of imaging devices. An exemplary MFP may comprise the functions of a printer, scanner, copier and fax machine.

Some imaging devices may comprise computing resources for data storage and processing such as processors, hard disk drives, memory and other computing resources. As imaging devices add more features and functions, the imaging devices may become more costly and complex.

Some imaging devices and MFPs may comprise network connectivity to provide communication with other computing devices, such as personal computers, other imaging devices, network servers and other apparatus. This connectivity may allow the imaging device to use off-board resources that are available on a connected network.

### BRIEF SUMMARY OF THE INVENTION

Some embodiments of the present invention comprise systems, methods and devices for providing authenticated digital data from an imaging device, wherein a private encryption key may be securely stored. Some embodiments of the present invention comprise remote computing devices configured to communicate with imaging devices, imaging devices configured to communicate with remote computing devices and systems comprising various combinations of remote computing devices in communication with imaging devices, wherein authenticated digital data may be provided from the imaging devices.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 is a diagram of an embodiment of the present invention comprising an imaging device in connection with a remote computing device;

FIG. 2 is an image of an exemplary user interface for an imaging device;

FIG. 3 shows an exemplary imaging device;

FIG. 4 is a chart depicting steps of an imaging device method;

FIG. 5 is a chart depicting steps of an imaging device method using a markup language;

FIG. 6 shows an exemplary remote computing device embodiment;

FIG. 7 is a diagram showing components of an exemplary remote computing device;

FIG. 8 is a chart showing steps of a remote computing device method;

FIG. 9 is a chart showing steps of a remote computing device method using a markup language;

FIG. 10 is a diagram showing a system comprising multiple imaging devices in connection with a remote computing device;

FIG. 11A is a chart showing steps of a method that may be employed by the system depicted in FIG. 10;

FIG. 11B is a chart showing steps of an embodiment comprising selection of a preferred language;

FIG. 12 is a diagram showing elements of a system embodiment of the present invention;

FIG. 13 is a chart showing embodiments of the present invention comprising storage of a secure private key on an imaging device;

FIG. 14 is a chart showing embodiments of the present invention comprising generating a device signature for authenticating digital image data;

FIG. 15 is a chart showing embodiments of the present invention comprising time stamping;

FIG. 16 is a chart showing embodiments of the present invention comprising generating a time stamp and a device signature for digital image data;

FIG. 17 is a chart showing embodiments of the present invention comprising generating a time stamp and a device signature for digital image data;

FIG. 18 is chart showing embodiments of the present invention comprising generating a user signature and a device signature for digital image data;

FIG. 19 is a chart showing embodiments of the present invention comprising generating a user signature and a device signature for digital image data;

FIG. 20 is a chart showing embodiments of the present invention comprising generating a user signature and a device signature for digital image data;

FIG. 21 is a chart showing embodiments of the present invention comprising an imaging device in communication with a remote computing device to generate user signatures; and

FIG. 22 is a chart showing embodiments of the present invention comprising a remote computing device generating a user signature to be affixed at an imaging device to image data generated at the imaging device.

### DETAILED DESCRIPTION

Embodiments of the present invention will be best understood by reference to the drawings, wherein like parts are designated by like numerals throughout. The figures listed above are expressly incorporated as part of this detailed description.

It will be readily understood that the components of the present invention, as generally described and illustrated in the figures herein, could be arranged and designed in a wide variety of different configurations. Thus, the following more detailed description of the embodiments of the methods and systems of the present invention is not intended to limit the scope of the invention but it is merely representative of the presently preferred embodiments of the invention.

Elements of embodiments of the present invention may be embodied in hardware, firmware and/or software. While exemplary embodiments revealed herein may only describe one of these forms, it is to be understood that one skilled in the art would be able to effectuate these elements in any of these forms while resting within the scope of the present invention.

Some embodiments of the present invention comprise interfaces and architecture that integrate imaging devices with remote computing device applications and environments to provide solutions that may not be possible solely with an imaging device alone. Some embodiments comprise an infrastructure and set of interfaces that allow applications on a network to programmatically control imaging device functions and interact with a user through an imaging device input panel. Software functions that may not be practical within the imaging device may be performed on the server but may be accessible from the imaging device.

For the purposes of this specification and claims, an imaging device (IDev) may be described as a device that performs an imaging function. Imaging functions comprise scanning, printing, copying, image transmission (sending and receiving), image conversion and other functions. Exemplary imaging devices comprise printers, copiers, facsimile machines, scanners, computing devices that transmit, convert or process images and other devices. An IDev may also perform multiple imaging functions. An exemplary imaging device may be a multi-function peripheral device (MFP) comprising the capability to perform a plurality of imaging functions. An exemplary MFP may comprise the functions of a printer, a scanner, a copier and a facsimile machine or image transmitter/receiver. Other MFP imaging devices may comprise other combinations of imaging functions and still qualify as an IDev.

For the purposes of this specification and claims, a remote computing device (RCD) is a device capable of processing data and communicating with other devices through a communications link. An RCD is a remote device because it requires a communications link, such as a network connection, a telephone line, a serial cable or some other wired or wireless link to communicate with other devices such as an imaging device. Some exemplary RCDs are network servers, networked computers and other processing and storage devices that have communications links.

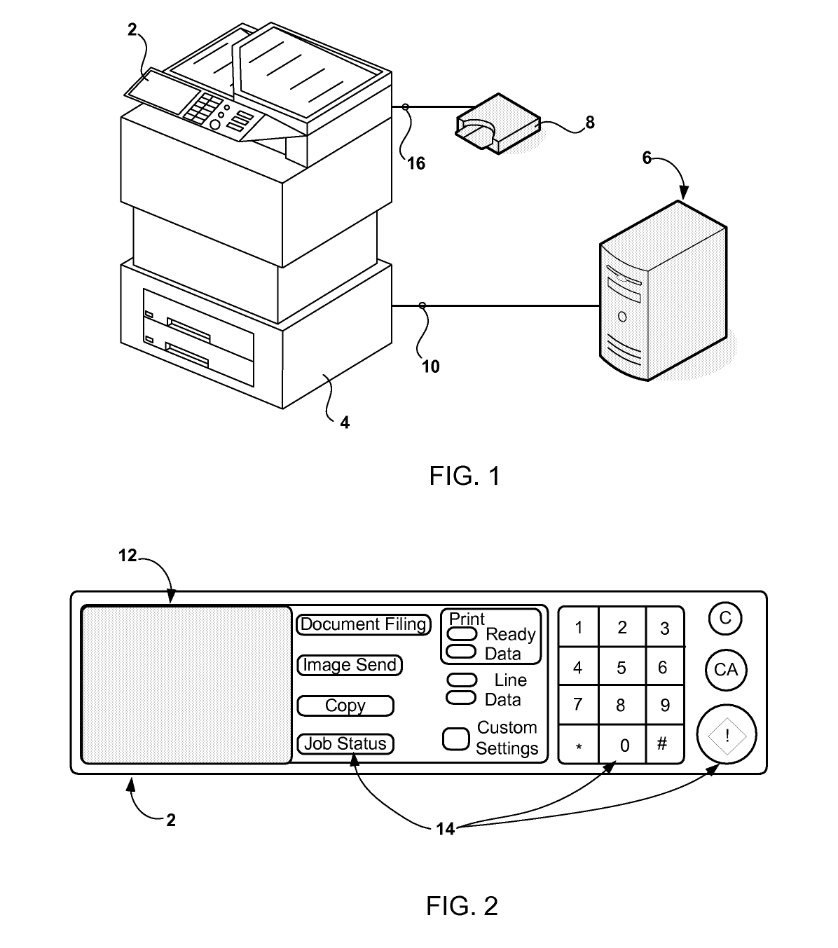

Some embodiments of the present invention may be described in relation to FIG. 1 and FIG. 2. These embodiments comprise an imaging device (IDev) 4 that may be a multi-function peripheral device (MFP) or a single-function device. The imaging device 4 further comprises a user interface (UI) panel 2, which may comprise input buttons 14 and a display device 12 or may comprise a touch panel system with or without buttons 14. User input and display may also be performed through a separate UI device 8, which may be connected to the imaging device 4 by a communication link 16, such as a USB connection, a network cable, a wireless connection or some other communications link. The separate UI device 8 may comprise an input device, such as a keyboard or buttons, as well as a display device, which may also be a touch screen panel. The separate UI device 8 may also comprise an interface for transfer of instructions that are input to the device 8 from a remote input device. This form of the UI device 8 may comprise memory sticks, Universal Serial Bus (USB) memory cards and other storage devices that may be configured to store input for transfer to an imaging device.

These embodiments further comprise a remote computing device (RCD) 6 that is linked to the imaging device 4 via a communications link 10, such as a network connection. This network connection may be a typical wired connection or a wireless link.

Embodiments of the present invention may provide menu data from the RCD 6 to the imaging device UI panel 2 or remote panel 8 via the network connection 10. Once this menu data is fed to the imaging device 4, an UI panel 2, 8 on the imaging device 4 may be used to interact with applications that run on the remote computing device 6. User input received from UI panels 2, 8 may be returned directly to the remote computing device 6.

A Web Service is a software application identified by a Uniform Resource Identifier (URI), whose interfaces and binding are capable of being defined, described and discovered by Extensible Markup Language (XML) artifacts and supports direct interactions with other software applications using XML based messages via Internet-based protocols.

An application on the remote computing device 6 may use one or more Web Services to control various features in the imaging device 4, such as enabling, disabling or setting device values or controlling device functions.

Some embodiments of the present invention allow network applications running on remote computing devices to interact with the user of the imaging device through the imaging device I/O panel. These embodiments allow imaging device user interface (UI) control (e.g., touch panel, button/display) by applications. Some embodiments may also integrate custom display screens or menus with the native imaging device UI. Embodiments may hand off control of imaging device functions between standard operation modes performed on the imaging device in response to user input to an imaging device UI and open systems modes that utilize network resources, such as applications on RCDs, through user input at the imaging device UI.

Some embodiments of the present invention comprise network-based applications that may have full control over the imaging device UI to display text and graphics in any format. In these embodiments, the application may programmatically display buttons, textboxes, graphics, etc. in any layout desired.

In some embodiments, the UI layout may be programmed using a standard language, such as a markup language. These languages comprise Hypertext Markup Language (HTML), Extensible Markup Language (XML), Wireless Markup Language (WML), Extensible Hypertext Markup Language (XHTML) and other languages.

In some embodiments of the present invention a remote computing device application or server application may be able to request a keyboard UI to be displayed on the imaging device display 12, 8. In some embodiments, this functionality may be available on the imaging device and may not need to be recreated by remote computing device applications. In some embodiments, the remote computing device may define the keyboard prompt and default values. These embodiments may comprise a remote computing device that is able to rename imaging device UI buttons, such as the “OK” and “Cancel” buttons, as well as define additional buttons.

In some embodiments, menu templates may be served to the imaging device UI by the imaging device 4 or from a remote computing device 6.

External Authorization Application

Some embodiments of the present invention may comprise a remote computing device application that is registered as the External Authorization server. The External Authorization application may control access to the imaging device and may have top-level control of the UI. UI control may be given to this application in the same manner that control is given to an internal auditor.

In these embodiments, when an imaging device system boots, it may check to see if an External Authorization application is registered. If so, the imaging device may be placed in disabled mode and the application may be contacted to take control of the UI. If the External Authorization server is not available, an error message may be displayed and the device may remain disabled. The imaging device may periodically try to contact the External Authorization server until it is available. Table 1 below describes what entity has control of the UI, in an exemplary embodiment, when the device is in a disabled state.

TABLE 1
UI Control in Disabled State

| | | Indicator |
|---|---|---|
| Button Press | UI Control | Lights |
| Device boots | External Application | None |
| Document Filing | External Application | None |
| Image Send | External Application | None |
| Copy | External Application | None |
| Job Status | Device - standard Job Status screens | Job Status |
| Custom Settings | Device - standard Custom Settings | N/A |
| | screens | |

| | |
|---|---|
| OS Mode | Not available when device is disabled |

Remote Computing Device Applications

In some embodiments of the present invention, access to the custom UI panels of imaging devices may vary from application to application. Some solutions, such as Document Management integration, may wish to leverage the native Image Send screens, but display some custom UI's to gather additional information about a scan job. Other solutions, like custom printing applications, may be accessed from a separate mode than the native functions.

In order to accommodate the diversified needs of these solutions applications, embodiments may support multiple integration points for UI control. These integration points may be based on a user action (“trigger”) for which applications may register. In some embodiments, applications may be registered with target devices so that the device knows that when a particular trigger occurs on the front panel to contact an associated particular remote computing device for instructions. In exemplary embodiments, applications may be integrated with an imaging device at any of several trigger points.

Remote computing devices may be registered to a specific function and contacted when that function's hardware key is pressed (e.g., “Image Send”) on the imaging device UI. UI information provided by the remote computing device may be displayed instead of the standard function screens native to the imaging device. This trigger may be used for applications that wish to replace the existing functions with completely custom UI's, such as an alternative scan solution or a specialized display, such as a “Section 508” compatible screen or other specialized-need interface that may have large buttons or other accommodations.

In some embodiments, each function on the imaging device may have a menu on the touch screen that remote computing devices, such as servers, can register. This enables solutions applications to provide custom content and still use some of the standard functionality provided by the imaging device. When a button assigned to a custom application is selected, a menu may be displayed with the solutions registered to that function. Users may select the desired solution and the remote computing device may be contacted for instructions.

In some embodiments, a stand-alone RCD mode that provides remote computing device application access can be accessed from the job queue portion of the UI that is displayed on every screen. This trigger point may be used for applications that do not fit within one of the standard device functions, such as custom printing solutions on an imaging device. When the RCD menu is selected, a menu may be displayed with the solutions applications registered to the generic RCD mode. Users may select the desired solution and the remote computing device will be contacted for instructions.

Hardware Key Interaction

In some embodiments of the present invention, when an imaging device is enabled, additional hardware keys may be used to manage the device. Hardware key assignments for an exemplary embodiment are shown in Table 2.

TABLE 2
Exemplary Hardware Key Assignments

| | Standard IDev | |
|---|---|---|
| Button Press | Mode | RCD Mode |
| Mode keys (Copy, | Clear current job | Clear current job settings, |
| Doc Filing, Image | settings, move to | move to target screen |
| Send) and Custom | target screen | |
| Settings key | | |
| Job Status key | Move to Job Status, | Move to Job Status, |
| | maintain current | maintain current settings & |
| | settings & UI | UI location |
| | location | |
| Clear (C) | Clears settings | Sends clear event to external |
| | | application |
| Clear All (CA) | Clears settings, | Cancels job and returns to |
| | cancels job, and | default IDev screen |
| | returns to default | (notification sent to external |
| | IDev screen | application) |
| | | **When External |
| | | Authorization is controlling |
| | | the UI, only notification is |
| | | sent |
| Start | Initiates scan | Initiates scan function |
| | function | |
| Number keys | Input for copy count | Not used |
| | or fax numbers | |
| * | Logs user out | Logs user out (disable |
| | (disable device and | device and contact External |
| | contact External | Authorization for screens) |
| | Authorization | |
| | for screens) | |

In some embodiments, in addition to the “*” key for logout, a timeout period may be implemented. Some embodiments also comprise an auto clear setting that can be configured 10 for a given period of time, such as 10 to 240 seconds (or disabled). In these embodiments, when there is no activity for the time configured in auto clear, the device may automatically return to disabled mode and attempt to contact a remote computing device to retake control of the UI.

Error & Jam Notifications

Depending on a particular solution, a remote computing device application may have full or only partial control of the imaging device UI and a particular imaging job. In some embodiments, partial control may include cases where a remote computing device is monitoring clicks, but native modes are responsible for the UI interaction and controlling the job. Partial control may also include cases where the remote computing device application is integrated with a native mode (UI trigger=function custom menu). In these embodiments, the imaging device may handle all error and jam notifications with only a notification sent to the relevant remote computing device application.

For some embodiments, in cases where the remote computing device application has full control over the UI and the job, error and jam notifications may be handled differently depending on the type of error. For recoverable errors, a notification may be sent to the remote computing device application and the application may be responsible for displaying messages and resolving the error. For non-recoverable errors, the imaging device and RCD mode may interact to gracefully handle the error condition (e.g., provide user with instructions for clearing jam).

Control Handoffs

In some embodiments, at different points throughout an imaging job, several applications may require control over an imaging device including, but not limited to, an External Authorization application, a standard RCD application, an imaging device native mode and other applications. The following section describes, for an exemplary embodiment, the various steps in an exemplary job, the entities that may have control during each step, and what type of control may be allowed.

Step 1: User provides credentials to access the device at the device UI. This step may be controlled by a remote computing device, such as an External Authorization application or by Internal Accounting (native mode) in the imaging device itself. At the end of this step, the device is enabled. The External Authorization application may also specify default parameters or disable specific job parameters (e.g., default file format is PDF, but the user may change; color mode is set to B/W and the user may not change).

Step 2: User sets parameters for the job using one of the native imaging device modes or a standard RCD application. At the end of this step the user makes an input to initiate the job. When the input is made, an optional notification may be sent to the standard RCD application, which can then change job parameters if desired. An e-mail application is one example of an application that may request notification when the user input is made. A user may use native “Image Send” screens or other input to select scan options and choose e-mail recipients. A user may then select a custom application button and choose the scan-to-e-mail option from the menu. The e-mail application may then display custom screens for the user to set permissions for the file. Once a user places the original document(s) on the scanner and initiates the process, the e-mail application may capture the destination parameters set by the user and change the target destination to the e-mail application file transfer protocol (FTP) server. The e-mail application may then receive the file, apply the appropriate permissions, and send to the e-mail recipients selected by the user. A remote computing device application may also want to retake control of the UI at this point, if, as in some embodiments, the application generates thumbnails of the scanned images and displays them to the user for verification.

Step 3: Once the job is initiated, the imaging device is responsible for scanning or RIPing the job and spooling it to the hard disk drive (HDD). If the imaging device is configured to authorize jobs with an external authorization application, it may send a click report to the application and wait for instructions. The external authorization application may enable the job for sending/printing, cancel the job, or change job parameters (and then enable). As an example, a rules-based printing application may wish to change job parameters after it receives a click report. Some rules-based printing applications support rules-based printing and scanning that may limit what each user may be allowed to do based on the time of day, the destination, or many other parameters. For example, only users in the marketing group may be able to scan high-quality color images. If a user from another group selects color and 600 dpi, a rules-based application may change the parameters to color and 200 dpi. At the end of this step, the job may be either be authorized or canceled.

Step 4: In some embodiments, this may be an optional step, where the standard RCD application in step 2 may have specified the destination as a HDD for temporary storage. This step may also be used, in some embodiments, by a Java application running on the imaging device. For example, a government office may have a custom encryption application running on the device that takes the scanned document, encrypts it, and then requests the imaging device to send it to the target destination selected by the user in step 2. In some embodiments, it may be beneficial to send a notification to the external authorization application after this step—because the imaging device does not know how long the file will be on the HDD or what the application is going to do with it—and after the send/print step.

Step 5: In the final step, the file may be output. In typical embodiments, the file may either be sent over the network to be printed or printed locally. At the end of this step, a notification that the job was successfully completed may be sent to the external authorization application and optionally, to the standard RCD application.

Device Control and Management API's

The API's may be used to allow a remote computing device application to control access to an imaging device for vend applications and to manage the device from a remote location.

Device Control and Vend API

In some embodiments of the present invention, a Device Control and Vend API may allow applications to enable and disable access to the device and track click counts. The Device Control and Vend API may provide an RCD with the following controls:

Enable/disable device of function—this may allow an RCD to enable or disable access to the device as a whole or by function to enforce individual user privileges. In some exemplary embodiments, the functions listed in Table 3 may be selectively enabled or disabled by an application.

TABLE 3
Device Functions

| Enable/Disable | Description |
|---|---|
| Copy | Copy function |
| | (Copy button) |
| Image Send | Scan and fax function, plus send from Doc Filing |
| | (Image Send button) |
| Document Filing | All access to Document Filing functions |
| | (Document Filing button) |
| Print | Network prints, pull print from front panel, and |
| | print from Document Filing |
| | (No button control) |

Report clicks used—at the end of a successful job, the clicks used may be reported back to an RCD including:

TABLE 4
Job and Page Characteristics

| | | | | | | | |
|---|---|---|---|---|---|---|---|
| | | | Fax | PC- | E-mail/ | Broad- | Scan |
| Item | Copy | Print | Send | Fax | FTP | cast | to HD |

JOB Characteristics

| | | | | | | | |
|---|---|---|---|---|---|---|---|
| Job Mode | Yes | Yes | Yes | Yes | Yes | Yes | Yes |
| Broadcast | No | No | Yes | Yes | Yes | Yes | No |
| Manage No. | | | | | | | |
| User Name | Yes | Yes | Yes | Yes | Yes | Yes | Yes |
| Address | No | No | Yes | Yes | Yes | # | No |
| Start Time | Yes | Yes | Yes | Yes | Yes | Yes | Yes |
| End Time | Yes | Yes | Yes | Yes | Yes | Yes | Yes |
| Total Page | Yes | Yes | Yes | Yes | Yes | Yes | Yes |
| Result | Yes | Yes | Yes | Yes | Yes | Yes | Yes |
| Error Cause | No | No | Yes | Yes | Yes | Yes | No |
| Doc Filing | Yes | Yes | Yes | Yes | Yes | Yes | Yes |
| Save Mode | *1 | *1 | *1 | *1 | *1 | *1 | *1 |
| File Name | *1 | Yes | *1 | Yes | Yes | *1 | Yes |
| File Size | Yes | Yes | *1 | *1 | *1 | *1 | Yes |
| Resolution | Yes | Yes | Yes | Yes | Yes | Yes | Yes |
| Special | Yes | Yes | Yes | No | Yes | Yes | Yes |
| Finishing | Yes | Yes | No | No | No | No | No |
| File Format | No | No | No | No | Yes | Yes | No |
| Compression | No | No | No | No | Yes | Yes | No |

PAGE Characteristics

| | | | | | | | |
|---|---|---|---|---|---|---|---|
| Copy | Yes | Yes | Yes | Yes | Yes | # | Yes |
| Paper Size | Yes | Yes | Yes | Yes | Yes | Yes | Yes |
| Simplex/duplex | Yes | Yes | Yes | Yes | Yes | Yes | Yes |
| Paper Type | Yes | Yes | Yes | Yes | No | No | Yes |
| Page | Yes | Yes | Yes | Yes | Yes | Yes | Yes |

*1 - Yes when Document Filing is used

Debit mode—in these embodiments, when an application enables the device it may specify if the current job requires authorization. If so, the job may be spooled to memory and click information (e.g., as defined in Table 4) may be sent to an RCD. An RCD may then 10 notify the device if the job should be deleted or output sent. At this point, the application also may have the option of changing job parameters. If the application does not require authorization, the job may continue as normal and a click report may be sent at the end of the job.

Print job accounting—in these embodiments, an RCD may monitor print jobs in addition to walk-up functions. For print job accounting, an IDev may monitor all incoming print jobs and send accounting data in the PJL header to an RCD for verification before printing the job. The RCD may evaluate the accounting data (or lack thereof) and inform the IDev to continue with or cancel the job.

Report on unidentified jobs—in these embodiments, an RCD may also monitor print jobs that it cannot associate to a specific user, such as device reports and incoming fax jobs. The RCD may register to receive click counts for all unidentified jobs, so that it may bill them to a general account.

Device Management API

In some embodiments of the present invention, a Device Management API may allow a network application to remotely setup and manage the imaging device. In exemplary embodiments, the Device Management API may provide an RCD with the following controls:
Device status—an RCD may request the current status of the device. This may be the same status information as reported on the embedded web pages.
Device configuration—an RCD may retrieve a list of installed options supported by the device.
Web Page settings—an RCD application may retrieve and set any of the values that are configurable on the embedded web pages.
Key Operator Programs—an RCD application may retrieve and set any of the values that are configurable in Key Operator Programs, including software keys.
Custom Settings—an RCD application may retrieve and set any of the values that are configurable in Custom Settings.
Job Status—an RCD application may retrieve the current job queue and history information and reprioritize or delete jobs in the queue.
Click counts—an RCD application may retrieve device total counts and clicks for each function by account code.
Data Security settings—an RCD application may retrieve the status information on the DSK (e.g., last erase) and initiate data clear functions.
RED data—an RCD can retrieve all data typically sent in a RED message.
Remote reboot—an RCD can initiate a reboot of the imaging device.

The above groupings are provided only as an exemplary embodiment detailing which settings may be included. In some embodiments, API's may be grouped by functional areas since there may be overlap between Key Operator settings and web page settings.

Internal Accounting API

In some embodiments, an Internal Accounting API may allow a remote computing device application to configure internal accounting and report click counts. In some exemplary embodiments an Internal Accounting API may include:
Set Auditing Options—an RCD may set auditing options including which modes auditing is enabled for, “account number security” and “cancel jobs of invalid accounts.”
Manage Account Codes—an RCD may add, edit, or delete account codes.
Account Limits—an RCD application may specify a maximum number of clicks by function for individual account codes or for all account codes.
Account Reset—an RCD application may reset the click count for an individual account or for all accounts.
Retrieve Clicks—an RCD may retrieve the number of clicks by function for each account code.
   Font and Form Management API

Some embodiments of the present invention may comprise a Font and Form Management API, which may allow an RCD application to remotely download and manage fonts and forms in mass-storage. In some exemplary embodiments, a Font and Form Management API may provide a remote computing device with the following controls:
Mass storage control—an RCD application may retrieve mass storage status information including storage capacity, space available, and write-protect mode plus modify write-protect status.
Resource list—an RCD application may retrieve a list of stored fonts and forms including font or macro ID, font number, font/form name, escape sequence, and file size.
Download resource—an RCD application may download PCL fonts, PCL macros, and PS fonts and forms. Any special processing that may be performed when a resource is downloaded via the web pages may be performed when the resource is downloaded via embodiments of the present invention.
Delete resource—an RCD application may delete any resource stored in mass storage.
Upload resources—an RCD application may upload an individual resource or all resources. On devices where effective memory management is unavailable, a server application may use this function to “defrag” mass storage.
Font/macro ID's—an RCD application may assign or modify the ID's assigned to PCL fonts and macros.
   Firmware Management API

In some embodiments of the present invention, a Firmware Management API may allow a remote computing device or network application to remotely download and manage the imaging device firmware. In some exemplary embodiments, a Firmware Management API may provide a remote computing device (e.g., a server) with the following controls:
Firmware versions—an RCD application may retrieve the current firmware version numbers.
Service mode—an RCD application may place the MFP in service mode to lockout other jobs that will interfere with firmware upgrade. Upon receiving a service mode request, the IDev may stop accepting incoming jobs, complete all jobs in the queue, and then notify the server that it is in service mode.
Update firmware—an RCD may download an updated firmware version to the device. If a reboot is necessary, the IDev may perform it automatically when download is complete.
Download status—the IDev may send a status notification (success/error) to an RCD after firmware download.
Revert to previous version—if firmware update is not successful, the application may request the IDev to revert to the previous firmware version.
   Device Function API's

In some embodiments of the present invention, device function API's allow a remote computing device application to use existing imaging device functionality to provide new custom solutions.

Image Send API

In some embodiments, an Image Send API may provide the remote computing device application with the following controls:
Image Send Parameters—a remote computing device application may get and set values for the following scan and fax parameters:
   COLOR OR B/W
   IMAGE MODE—TEXT, TEXT/PHOTO, PHOTO; EXPOSURE LEVEL
   RESOLUTION
   FILE FORMAT—FILE TYPE, COMPRESSION, AND PAGES PER FILE
   ORIGINAL—ORIGINAL SIZE, SIMPLEX/DUPLEX, ROTATE, AND JOB BUILD
   FILENAME
   SUBJECT
   MESSAGE
   SENDER
   SCHEDULE SEND TIME
   PAGE DIVISION (BOOK SCANNING)
   COVER PAGE
   TRANSMISSION MESSAGE (CONFIDENTIAL, URGENT, ETC.)
   THIN PAPER SCANNING
   DESTINATION
   DOCUMENT FILING
Initiate Scan—the remote computing device application may initiate the scan function (same as a user pressing the “start” button).

In some embodiments, a remote computing device may change the default values on the imaging device or the values for the current job. For the current job, the remote computing device may also specify if scan parameters may be modified by the user or not. If one remote computing device application (e.g., Access Control) specifies that a parameter cannot be changed and then a second application (e.g., Document Management) tries to set the parameter, a notification may be sent to the second application and the setting will not be changed.

Print API

In some embodiments, print jobs may be submitted by remote computing device applications using standard printing channels. In some exemplary embodiments, a Print API may provide a remote computing device with the following additional control:
PJL sniffing—an RCD application may register with the IDev to be contacted for instructions when a specific PJL command is found in a print job. The RCD may then instruct the IDev to replace the command, cancel the job, or continue printing. This interface may be used in applications like accounting and other-brand compatibility.
   Copy API

In some embodiments of the present invention, a Copy API may provide a remote computing device with the following exemplary controls:
Copy Parameters—an RCD application may get and set values for the following copy parameters:
   COLOR OR B/W
   EXPOSURE—TEXT, TEXT/PHOTO, PHOTO, SUPER PHOTO; EXPOSURE LEVEL
   PAPER SELECT (BY TRAY)
   COPY RATIO
   2-SIDED COPY—1TO1, 1TO2, 2TO2, 2TO1; BINDING EDGE
      OUTPUT—OUTPUT TRAY, SORT, STAPLE, GROUP, OFFSET
   ORIGINAL SIZE
   SPECIAL FUNCTIONS—MARGIN SHIFT, ERASE, PAMPHLET, ETC.
   DOCUMENT FILING
Initiate Copy—an RCD application may initiate the copy function (same as a user pressing the “start” button).

In some embodiments, a remote computing device may change the default values on the imaging device or the values for the current job. For the current job, the remote computing device may also specify if copy parameters may be modified by the user or not.

Document Filing API

In some embodiments of the present invention, a Document Filing API may provide a remote computing device with the following exemplary controls:
Backup/restore—the remote computing device application may import and export a batch file with all Document Filing data. In some embodiments, this package may be in a proprietary format since it may contain documents that are password-protected and may not be accessed individually—for example when restoring in case of failure or cloning to other devices.
File/folder list—the remote computing device application may retrieve, modify, and create new files and folders to be stored on the IDev (also covered in device management).
Download file—the remote computing device may download a new file to the Document Filing systems and specify folder, filename, username, and password.
User list—the remote computing device application may retrieve, modify, and create new users to be stored on the IDev (also covered in device management).
HDD Status—the remote computing device application may retrieve the current HDD status comprising the % allocated to the main folder, quick folder, and custom folders and the % remaining.
Doc Filing Parameters—the remote computing device application may get and set values for storing a file to Doc Filing including the following exemplary parameters:
   EXPOSURE
   RESOLUTION
   ORIGINAL—SIZE, SIMPLEX/DUPLEX
   FILE INFORMATION—USERNAME, FILENAME, FOLDER, CONFIDENTIAL, PASSWORD
   SPECIAL MODES—ERASE, DUAL PAGE COPY, 2IN1, JOB BUILD, CARD SHOT
Initiate Print—the remote computing device application can select a stored file and initiate a print including the following exemplary parameters:
   PAPER SIZE/SOURCE
   OUTPUT—SORT/GROUP, OUTPUT TRAY, STAPLE, PUNCH, OFFSET
   SIMPLEX/DUPLEX (TABLET/BOOKLET)
   TANDEM PRINT
   NUMBER OF COPIES
   DELETE OR STORE AFTER PRINTING
Initiate Send—the remote computing device application may select a stored file and initiate a send including the following exemplary parameters:
   RESOLUTION
   FILE FORMAT
   DESTINATION
   TIMER
   SENDER
   FILENAME
   SUBJECT
   MESSAGE
      Security

Allowing external applications to control an imaging device may open up the imaging device to new security vulnerabilities. In embodiments of the present invention that provide some security measures, the following exemplary items are security concerns that may be addressed by the remote computing device interface.

Access to remote computing device interfaces may be limited to valid applications. Embodiments may provide extensive access and control of the imaging device, which may pose a significant security risk. The interface of these embodiments may be protected from access by attackers, while maintaining ease of setup and use for valid solutions.

Confidential data (for example, user credentials and job data) may be protected during network transfer. User credentials and job data may be secured during network transfer to ensure that it cannot be stolen, an intruder cannot monitor device activity, and a man-in-the-middle attack cannot change messages. Imaging devices may support Secure Sockets Layer (SSL) and other connections to ensure data is safe while being communicated between the imaging device and remote computing device applications.

Administrators may have the ability to lock-down imaging device access. For users with strict security policies, administrators may have the ability to disable access by remote computing devices or limit access to specific applications. Administrators may have an option to register the limited applications that they wish to access the imaging device interfaces.

Remote computing device applications may ensure the imaging device is not being “spoofed.” The remote computing device may be able to authenticate an imaging device that it is in contact with to ensure an intruder cannot imitate the imaging device to collect network configuration and password information, monitor file/folder structures of a document management system, or spoof security settings and DSK (Data Security Kit) status of the imaging device.

A remote computing device may ensure that the server is not being “spoofed.” The imaging device must be able to authenticate all remote computing devices that it is in contact with to ensure that an intruder is not spoofing the remote computing device's IP address. By pretending to be the remote computing device, an intruder could steal user credentials, redirect scanned documents, change device settings or firmware, or bring down the access control system (either to provide access to unauthorized users or initiate a denial of service attack for valid users).

Access control/vend applications may not be compromised when a remote computing device is unavailable. When the remote computing device is unavailable, it may not be acceptable to provide open access to the device. If the remote computing device is unavailable at startup or becomes unavailable at anytime (e.g., someone disconnects network cable), the imaging device may immediately be disabled and an error message displayed.

An administrator may be able to adjust a security level based on company and application requirements. Security requirements may have a large impact on the time it takes to develop a remote computing device application and the resources required to implement the solution. Users using some embodiments of the present invention may range from a small business with one imaging device, no IT staff, and a simple scan or print application to a large government office using access control and audit trails to track all device activity. The security measures used to protect imaging device interfaces may be adjustable by the administrator to match the target environment.

The imaging device and remote computing device applications may be able to hand-off user credentials. Users may be prompted to login at multiple points throughout a job. For example, an access control application or accounting application may control total device access, the imaging device may have user authentication enabled for Image Send, and a document management application may require user login before showing a folder list. In many environments, all of these applications will use a common user database. In some embodiments, it may be desirable for the applications to pass user credentials to each other, so that each one does not have to repeat the authentication process.

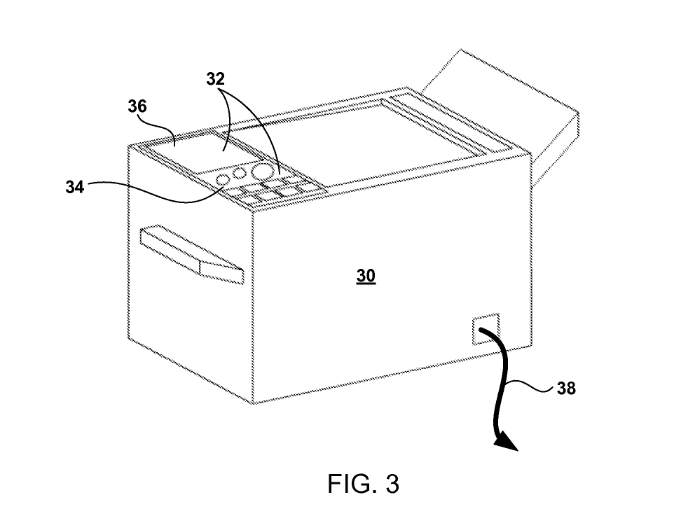

Some embodiments of the present invention may be described in relation to FIG. 3. These embodiments may comprise an imaging device only, which is configured to interact with a remote computing device, such as a server, through a communications link. The imaging device 30 comprises a user interface 32, which comprises a user input device 34, such as a keypad, one or more buttons, knobs or switches or a touch-screen panel and a display 36, which may comprise user input device 34 in the form of a touch-screen panel.

The imaging device 30 may be capable of performing one or more imaging functions including, but not limited to, scanning, printing, copying, facsimile transmission (sending and receiving) and others.

These embodiments further comprise a communications link 38, which may be a wired connection (as shown in FIG. 3) comprising a network cable, a Universal Serial Bus (USB) cable, a serial cable, a parallel cable, a powerline communication connection such as a HomePlug connection or other wired connections. Alternatively, the communications link 38 may comprise a wireless connection, such as an IEEE 802.11(b) compliant connection, a Bluetooth connection, an Infrared Data Association (IrDA) connection or some other wireless connection.

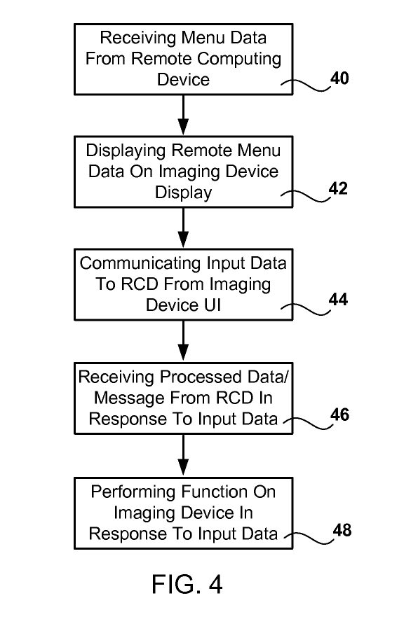

The operation of some imaging device embodiments may be explained with reference to FIG. 4. In these embodiments, menu data may be received 40 from a remote computing device (not shown in FIG. 3), which may connected to the imaging device 30 via the communication link 38 through a wired or wireless connection. This menu data may be then displayed 42 on the imaging device user interface display 36. This display of remote menu data may be intended to prompt a user to make an input on the user interface input device 34.

Imaging devices of these embodiments may be further configured to accept input from a user in response to a display of remote menu data and may communicate 44 that user input to a remote computing device. In some embodiments, this user input data may be processed by a remote computing device. This may comprise running an application on the remote computing device. This processing may also comprise accessing and communicating data that is stored on the remote computing device.

The imaging devices of these embodiments are further configured to receive 46 data resulting from processing the user input data. This may comprise data generated by an application running on the remote computing device in response to the user input. The imaging device may also receive data that was stored on a remote computing device, such as a file server, in response to processing the user input.

Once the imaging device 30 has received 46 the processed data, the imaging device 30 may perform 48 a native function in response to the data or using the data. For example, and not be way of limitation, the imaging device 30 may print a document that was stored on the remote computing device and modified on the remote computing device according to the user input. As another non-limiting example, the imaging device 30 may active or enable functions (e.g., scanning, copying, printing, fax transmission) on the imaging device in response to the receipt 46 of processed data.

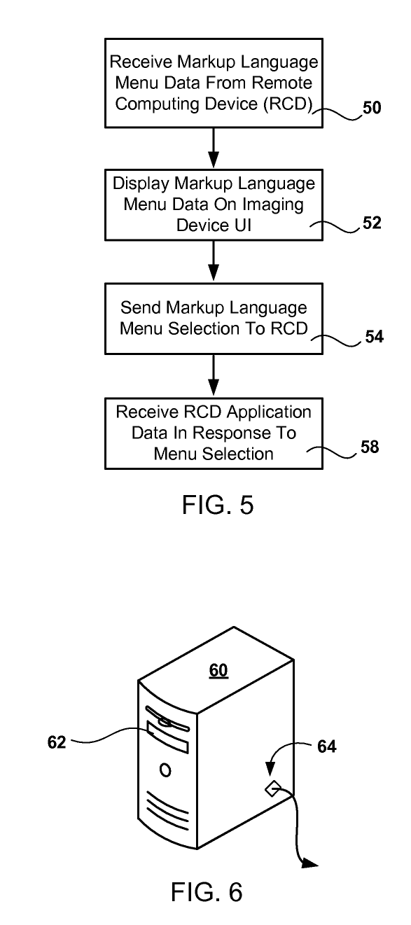

Some, more specific, imaging device embodiments may be explained with reference to FIG. 5. In these embodiments, the imaging device 30 is configured to receive 50 menu data formatted in a markup language from a remote computing device. The communication link by which the menu data is communicated may be established and maintained using a Hypertext Transfer Protocol (HTTP). The markup language may comprise terms from Hypertext Markup Language (HTML), Extensible Markup Language (XML), Wireless Markup Language (WML), Extensible Hypertext Markup Language (XHTML) and/or other languages.

Once the menu data is received 50, it may be displayed 52 on the imaging device user interface display 36. As in previously described embodiments, the menu data may be intended to prompt user input on imaging device user interface 32. Display 52 of the remotely-stored menu data may be accomplished with a browser application that is native to the imaging device 30.

In these embodiments, the imaging device 30 may be configured to route 54 user input received though its user interface 32 to a remote computing device. The remote computing device that receives the user input may then run an application or otherwise process the user input and return the results of the processing to the imaging device 30. Accordingly, the imaging device 30 may be configured to receive 56 processed data from a remote computing device. In some embodiments, the imaging device 30 may perform one or more functions in response to the receipt 56 of processed data.

Some embodiments of the present invention may be explained with reference to FIG. 6. These embodiment comprise a remote computing device (RCD) 60, which has a communications link 64. The communications link 64 may be a wired connection (as shown in FIG. 6) comprising a network cable, a Universal Serial Bus (USB) cable, a serial cable, a parallel cable, a powerline communication connection such as a HomePlug connection or other wired connections. Alternatively, the communications link 64 may comprise a wireless connection, such as an IEEE 802.11(b) compliant connection, a Bluetooth connection, an Infrared connection, such as those defined in the Infrared Data Association (IrDA) standard or some other wireless connection. In some embodiments, the RCD 60 may further comprise a data storage device 62, which is typically a hard drive, but may also be an optical drive device, such as an array of compact disk drives, flash memory or some other storage device.

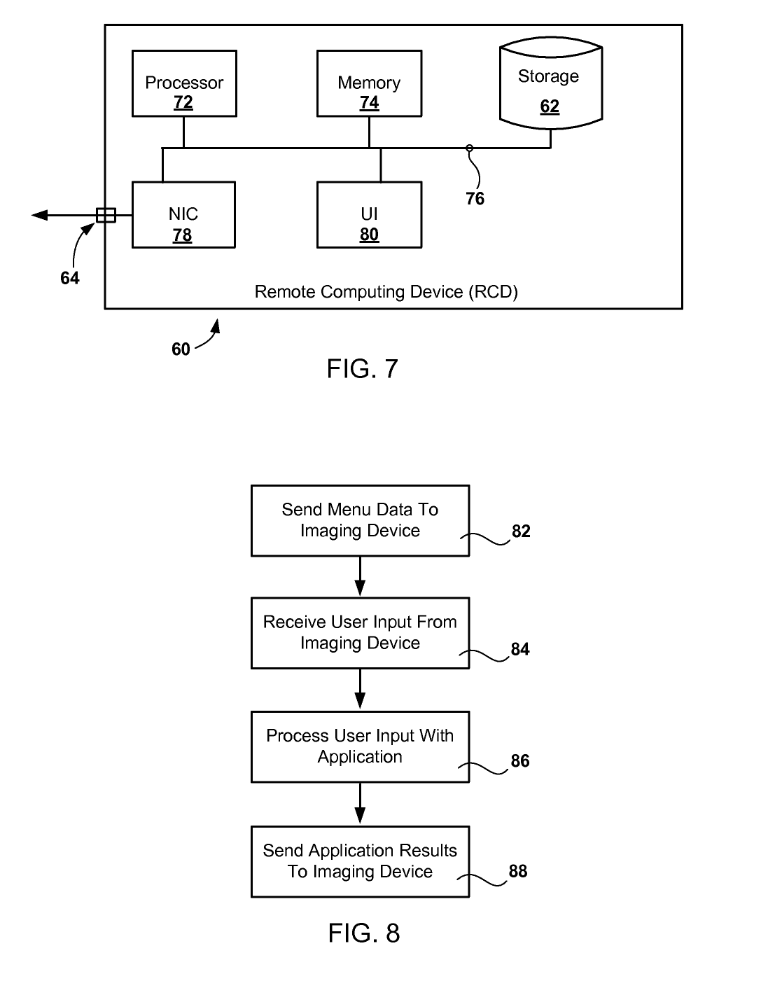

Embodiments of the RCD 60 may be further described with reference to FIG. 7. In these embodiments, the RCD 60 comprises a processor 72 for processing data and running programs such as operating systems and applications. RCD 60 may further comprise memory 74, which may be in the form of Random Access Memory (RAM) and Read Only Memory (ROM). Applications processed by processor 72 may be loaded into memory 74. The RCD 60 may further comprise a network interface 78, which allows the RCD 60 to communicate with other devices, such as an imaging device 30. In some embodiments, the RCD 60 may also comprise a user interface 80, but this may not required in many embodiments. The storage 62 may be used to store applications and data that may be accessed by an imaging device 30 of embodiments of the present invention. The processor 72, memory 74, storage 62, network interface 78 and, optionally, user interface 80 may be linked by a system bus 76 to enable data transfer between each component. The communications link 64 may couple the RCD 60 to other devices via network interface 78.

In some embodiments, described with reference to FIG. 8, an RCD 60 may comprise menu data stored on storage device 62 or in memory 74. This menu data may be configured for display on an imaging device user interface 32. Menu data may be stored in many formats and configurations. In some embodiments, menu data may take the form of terms expressed with a markup language. The markup language may comprise terms from Hypertext Markup Language (HTML), Extensible Markup Language (XML), Wireless Markup Language (WML), Extensible Hypertext Markup Language (XHTML) and/or other languages. In these embodiments, menu data may be sent 82 through a communications link 64 to an imaging device 30. Accordingly, menu data configured for display on an imaging device may be stored on the RCD 60.

An RCD 60, of some embodiments, may be further configured to receive 84 user input obtained through the user interface 32 of an imaging device 30 and transferred to the RCD 60 over communications links 38 and 64. Once this input data is received at an RCD 60, the input data may be processed 86. Exemplary processing 86 may comprise conversion of the data to a new format, execution of commands contained within the data or some other process. Once the input data has been processed 86, the processed output may be sent 88 back to the imaging device 30 where the processed output may be used in an imaging device process or function.

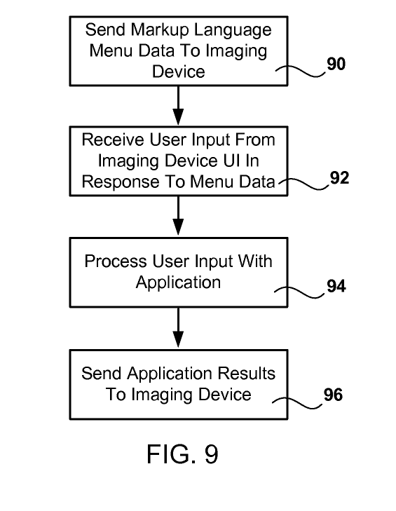

In some embodiments, as described with reference to FIG. 9, an RCD 60 may send 90 menu data configured for an imaging device display 36 using a markup language. The markup language menu data may be then received at the imaging device 30 and displayed to a user. This may prompt the user to enter an input on the imaging device user interface 32. This user input may be sent by the imaging device 30 to the RCD 60. The RCD 60 may then receive 92 the input data prompted by the display of the menu data on the imaging device 30. Once received, the input data may be processed 94 on the RCD 60. Processing may comprise the selection, recordation and/or modification of a form, document or other data stored on RCD 60, the authorization of a user identified by the user input, the translation of a document input by the user, generation of a map or other directions related to user input or some other process or function.

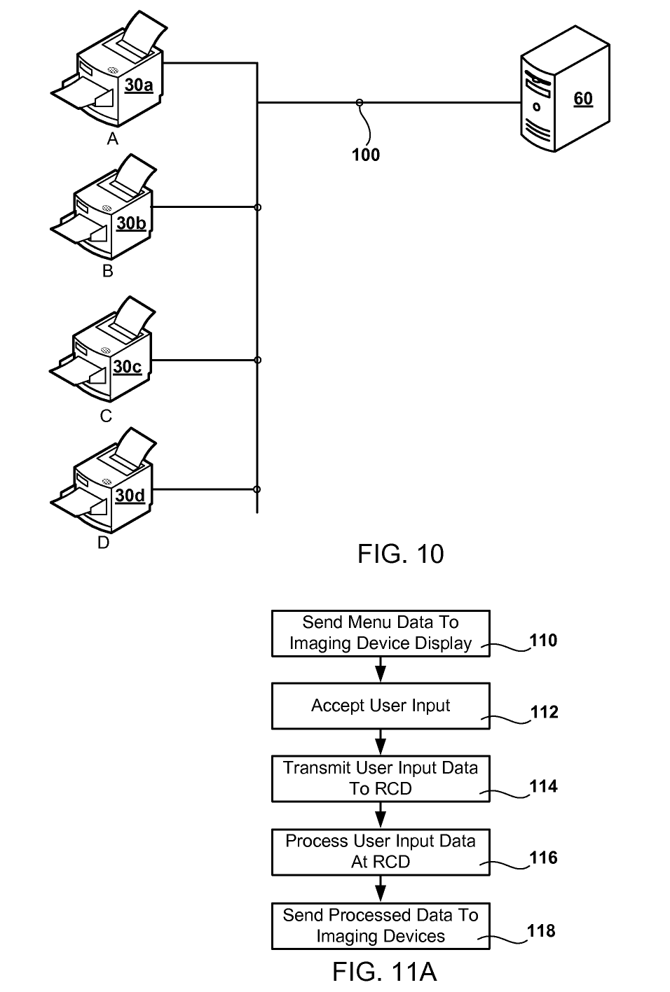

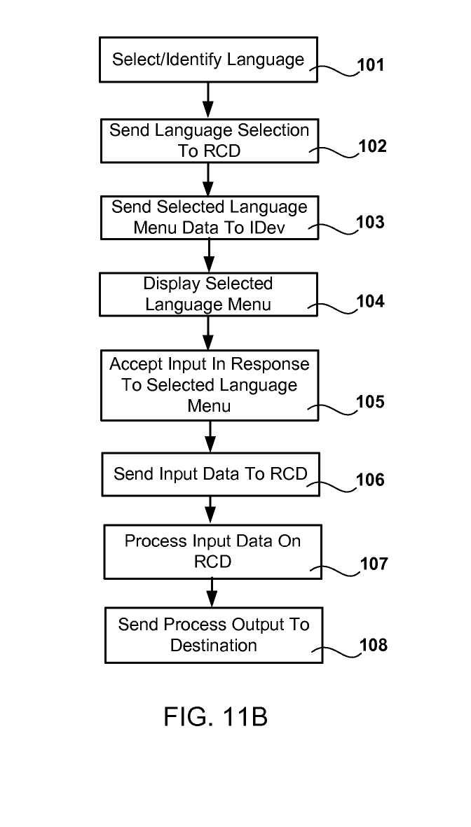

Some embodiments of the present invention may be described with reference to FIG. 10 and FIG. 11A. These embodiments comprise at least one RCD 60 and a plurality of imaging devices 30a-30d. In these embodiments, at least one of the imaging devices 30a-30d comprises a user interface 32 with a display 36 and user input panel 34 that is integral with the display (e.g., touch-screen) or a separate input unit. The RCD 60 may be connected to the imaging devices 30a-30d by a communications link and network 100 to enable data transmission between the RCD 60 and the imaging devices 30a-30d.

In these embodiments, menu data may be stored on the RCD 60 and sent 110 to at least one of the imaging devices 30a-30d where the menu data may be displayed on a user interface. Any of the imaging devices 30a-30d that receive the menu data may be configured to accept 112 and transmit 114 user input to an RCD 60. Once the user input data is received at the RCD, the data may be processed 116 as discussed in previously described embodiments. The result of processing 116 may then be sent 118 back to any combination of the imaging devices 30a-30d.

In these embodiments, a single RCD 60 may be used to provide processing power, resources and functionality to a plurality of imaging devices 30a-30d without reproducing these resources in each imaging device. In some embodiments, data generated by input on one imaging device 30a may be directed to another imaging device 30d for processed data output or final processing.

Some embodiments of the present invention may comprise multi-language menu support. Some of these embodiments, illustrated in FIG. 11B, may allow for an initial selection or identification 101 of a user-preferred language. This selection may comprise user input to select a preferred language. This step may also comprise an automatic identification of a user-preferred language which may be achieved by a user identification profile linked to a language, a language identification based on the text of a scanned document, a code printed on a scanned document or some other identification scheme.

Once the language has been selected, or otherwise identified, the selection/identification data may be sent 102 to an RCD, where the selection may be used to identify language-specific menu data that may be sent 103 to the imaging device for display 104. A user may then respond to the selected-language menu data with input 105, which may be used to invoke native imaging device functions or may be sent 106 to the RCD for any necessary processing. An RCD may then process 107 the input data and may send 108 any process input to a destination, such as the imaging device, an e-mail address, a memory location or some other destination.

Digital Signatures and Time Stamps

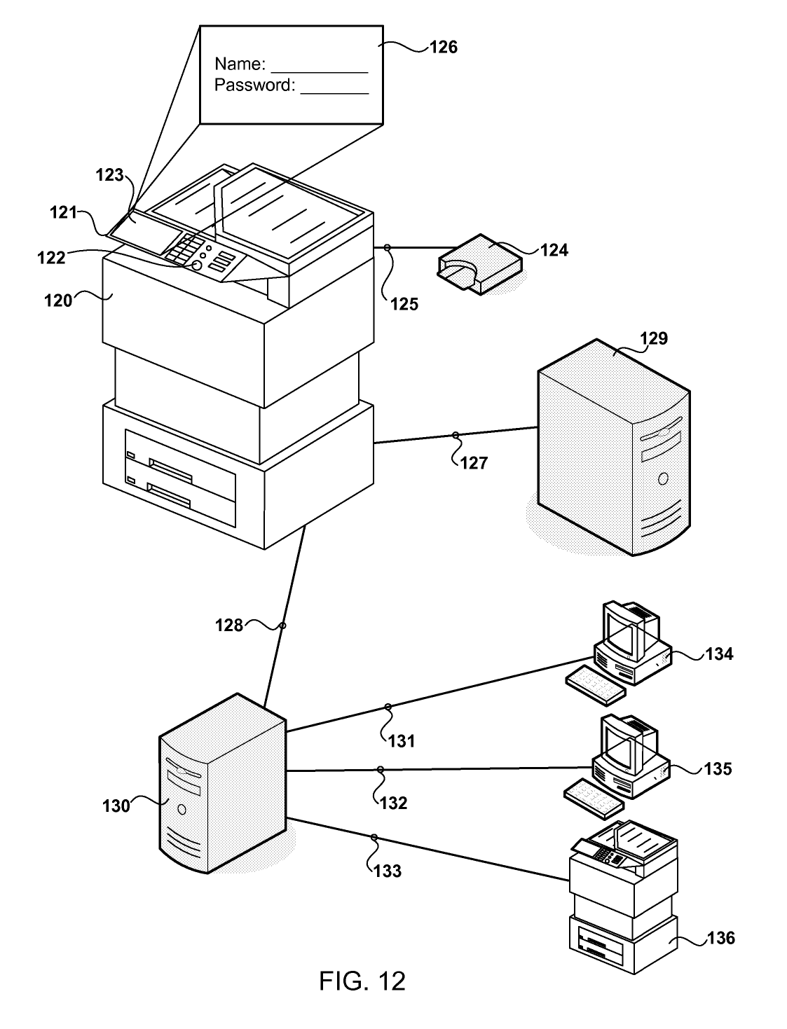

Some exemplary embodiments of the present invention may be described in relation to FIG. 12. In these embodiments, an imaging device (IDev) 120 may comprise a user interface (UI) panel 121, which may be capable of receiving user input and displaying data to a user. The UI panel 121 may comprise input buttons 122 and a display device 123. In some embodiments the display device 123 may comprise a touch panel system with or without buttons. In some embodiments, user input and display may be performed through a separate UI device 124, which may be connected to the imaging device 120 by a communication link 125, such as a USB connection, a network cable, a wired or wireless connection or some other communications link. The separate UI device 124 may comprise an input device, such as a keyboard or buttons, as well as a display device, which may be a touch screen panel. The separate UI device 124 may comprise an interface for transfer of instructions that are input to the imaging device 120 from a remote input device. This form of the UI device 124 may comprise memory sticks, USB memory cards and other storage devices that may be configured to store input for transfer to an imaging device. The display 123 on the imaging device UI panel 121 or the on the separate UI device 124 may be used to display data 126 to a user. This data may comprise menu data to prompt for a user selection or data entry, such as a user ID and password, application selection or some other input.

The imaging device 120 may be communicatively coupled 127, 128 to remote computing devices 129, 130 (two shown) via a computer network connection, a serial cable, a wired or wireless communication link or other communications link. Exemplary remote computing devices may comprise servers, personal computing devices and other computing devices. A remote computing device 129, 130 may be used to receive and store documents, such as scan data. An RCD 129, 130 may be used to store data, such as cryptographic keys and other data, and make that data accessible to the imaging device 120. An RCD 129, 130 may execute applications that interact with or receive input from the imaging device 120 and its user interface 121, 124.

A remote computing device 130 may be communicatively coupled 131-133 to additional remote computing devices 134, 135 (two shown) or additional imaging devices 136 (one shown).

In some embodiments of the present invention, a digital signature may be added at the imaging device 120 to image data generated at the imaging device 120. In some embodiments, the digital signature may be applied to the image data to authenticate the origin of the data as the imaging device 120 and provide for non-repudiation and to allow integrity checking.

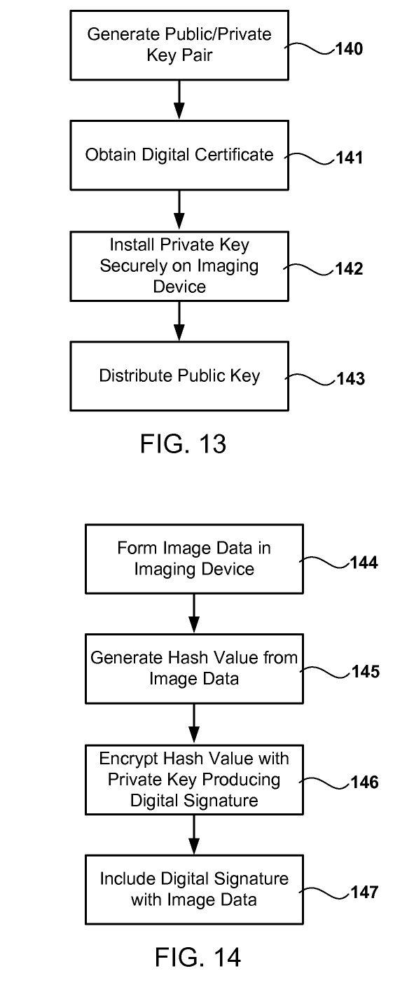

Some embodiments of the present invention may be described in relation to FIG. 13. In these embodiments, a public/private key pair may be generated 140. Exemplary methods for key pair generation 140 comprise RSA, DSA, MD5withRSA, El Gamal and other methods known in the art. A digital certificate may be obtained 141 after public/private key pair generation 140. In some embodiments, the digital certificate may be obtained 141 from an internal certificate server. In alternative embodiments, the digital certificate may be obtained 141 from an external certificate authority, such as VeriSign. The private key from the public/private key pair may be installed securely 142 on the imaging device 120, and the public key from the public/private key pair may be distributed 143 to intended recipients.

Some embodiments of the present invention may be described in relation to FIG. 14. In these embodiments, image data may be formed 144 in the imaging device 120. Exemplary methods by which the image data may be formed may comprise scanning a document at the imaging device, the process of receiving a fax, and the process of sending a fax. A hash value, also considered a message digest, may be generated 145 for the image data. Exemplary hashing algorithms comprise MD5, SHA-1, SHA-256 and other methods known in the art. The hash value may be encrypted 146 using the private key securely stored on the imaging device 120, thereby generating a digital signature. The digital signature may be included 147 with the digital image data. In some embodiments including 147 the digital signature with the digital image data may comprise concatenating the digital signature to the digital image data.

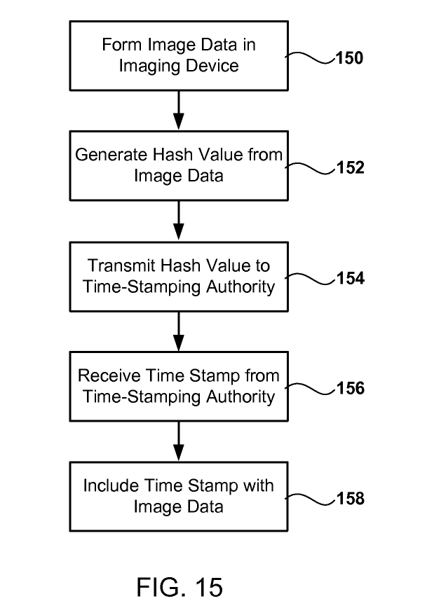

Some embodiments of the present invention may be described in relation to FIG. 15. In these embodiments, image data may be formed 150 in the imaging device 120. Exemplary methods by which the image data may be formed may comprise scanning a document at the imaging device, the process of receiving a fax, and the process of sending a fax. A hash value, also considered a message digest, may be generated 152 for the image data. Exemplary hashing algorithms comprise MD5, SHA-1, SHA-256 and other methods known in the art. The hash value may be transmitted 146 to a time-stamping authority (TSA) where a time stamp may be generated. The imaging device 120 may receive 156 the time stamp from the TSA and include 158, for example by concatenation, the time stamp with the digital image data.

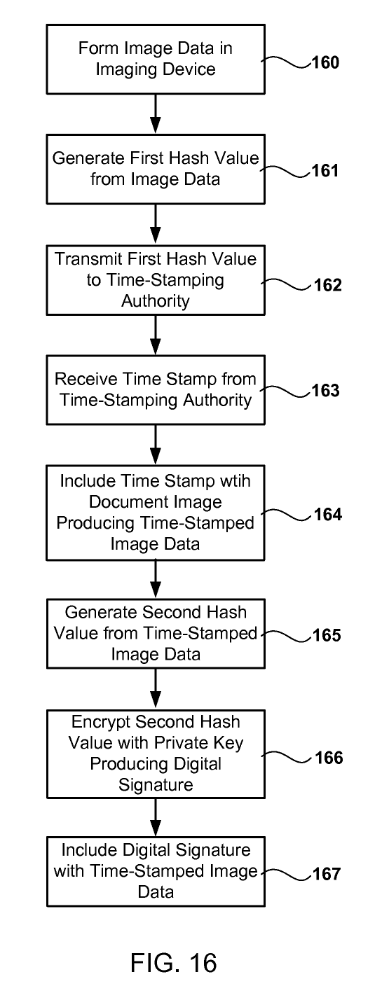

Some embodiments of the present invention may be described in relation to FIG. 16. In these embodiments, image data may be formed 160 in the imaging device 120. Exemplary methods by which the image data may be formed may comprise scanning a document at the imaging device, the process of receiving a fax, and the process of sending a fax. A first hash value, also considered a first message digest, may be generated 161 for the image data. Exemplary hashing algorithms comprise MD5, SHA-1, SHA-256 and other methods known in the art. The first hash value may be transmitted 162 to a time-stamping authority (TSA) where a time stamp may be generated. The imaging device 120 may receive 163 the time stamp from the TSA and may concatenate 164, or otherwise include, the time stamp to the digital image data. A second hash value may be generated 165. The second hash value may be generated 165 for the time-stamped document image. The second hash value may be encrypted 166 using the private key securely stored on the imaging device 120, thereby producing a digital signature of the imaging device. The digital signature may be included 167, for example by concatenation, with the time-stamped document image.

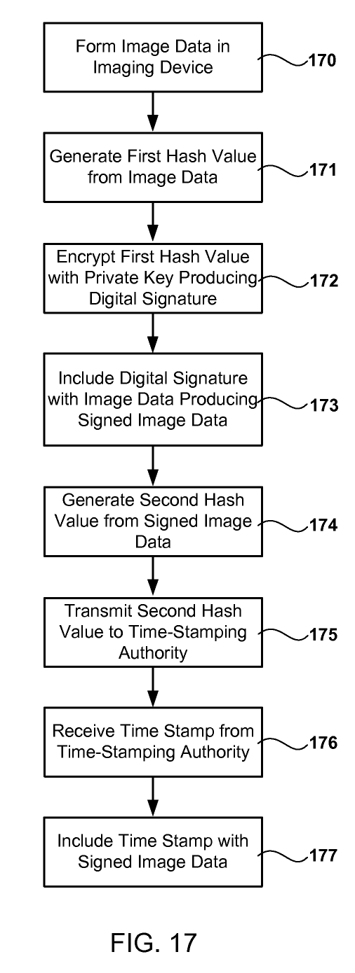

Some embodiments of the present invention may be described in relation to FIG. 17. In these embodiments, image data may be formed 170 in the imaging device 120. Exemplary methods by which the image data may be formed may comprise scanning a document at the imaging device, the process of receiving a fax, and the process of sending a fax. A first hash value, also considered a first message digest, may be generated 171 for the image data. Exemplary hashing algorithms comprise MD5, SHA-1, SHA-256 and other methods known in the art. The first hash value may be encrypted 172 using the private key securely stored on the imaging device 120, thereby producing a digital signature of the imaging device. The digital signature may be included 173, for example by concatenation, with the digital image data, thereby producing a signed digital document. A second hash value may be generated 174. The second hash value may be generated 174 for the signed document image. The second hash value may be transmitted 175 to a time-stamping authority (TSA) where a time stamp may be generated. The imaging device 120 may receive 176 the time stamp from the TSA and may include 177, for example by concatenation, the time stamp with the signed digital document.

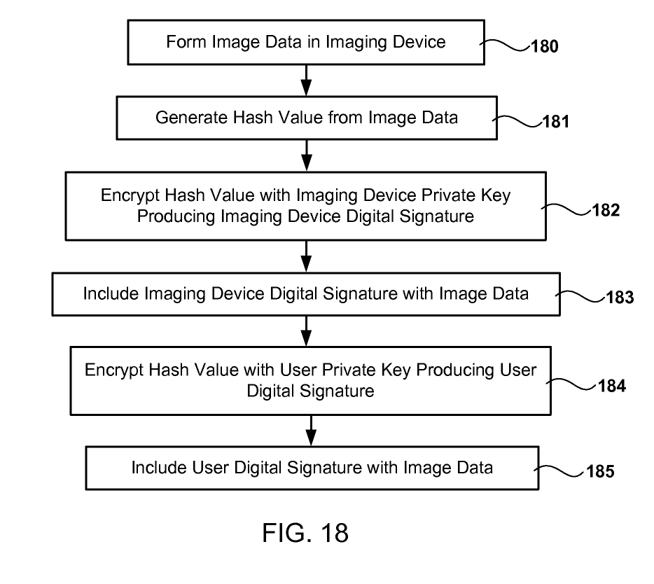

Some embodiments of the present invention may be described in relation to FIG. 18. In these embodiments, image data may be formed 180 in the imaging device 120. Exemplary methods by which the image data may be formed may comprise scanning a document at the imaging device, the process of receiving a fax, and the process of sending a fax. A hash value, also considered a message digest, may be generated 181 for the image data. Exemplary hashing algorithms comprise MD5, SHA-1, SHA-256 and other methods known in the art. The hash value may be encrypted 182 using the private key securely stored on the imaging device 120, thereby generating a digital signature. The digital signature may be included 183, for example by concatenation, with the digital image data. The hash value may be encrypted 184 using a private key associated with a user, thereby producing a user signature. The user signature may be included 185 with the digital image data. In some embodiments of the present invention, the private key associated with the user may be securely stored on the imaging device 120. In alternative embodiments, the private key associated with the user may be securely stored remote to the imaging device 120.

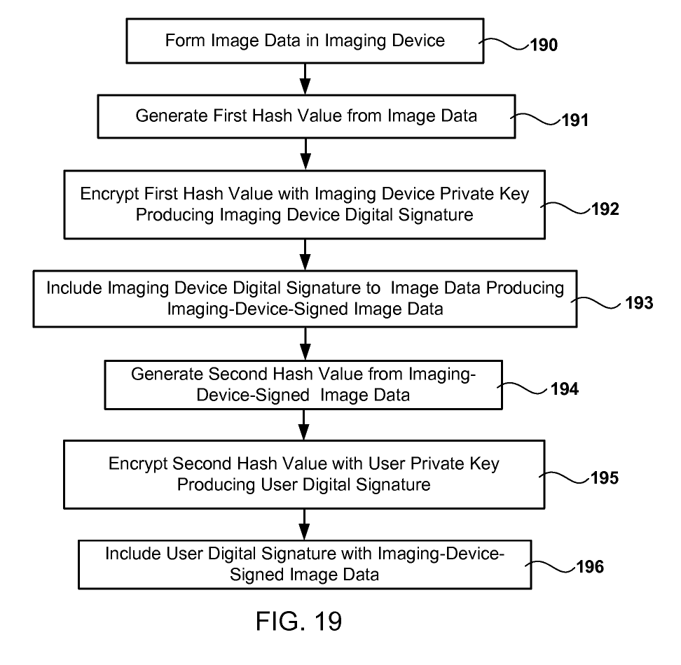

Some embodiments of the present invention may be described in relation to FIG. 19. In these embodiments, image data may be formed 190 in the imaging device 120. Exemplary methods by which the image data may be formed may comprise scanning a document at the imaging device, the process of receiving a fax, and the process of sending a fax. A first hash value, also considered a first message digest, may be generated 191 for the image data. Exemplary hashing algorithms comprise MD5, SHA-1, SHA-256 and other methods known in the art. The first hash value may be encrypted 192 using the private key securely stored on the imaging device 120, thereby generating a digital signature for the imaging device. The imaging device digital signature may be included 193, for example by concatenation, with the digital image data, thereby producing an imaging-device-signed document image. A second hash value may be generated 194 from the imaging-device-signed document image. The second hash value may be encrypted 195 using a private key associated with a user, thereby producing a user signature. The user signature may be included 196, for example by concatenation, with the imaging-device-signed document image. In some embodiments of the present invention, the private key associated with the user may be securely stored on the imaging device 120. In alternative embodiments, the private key associated with the user may be securely stored remote to the imaging device 120.

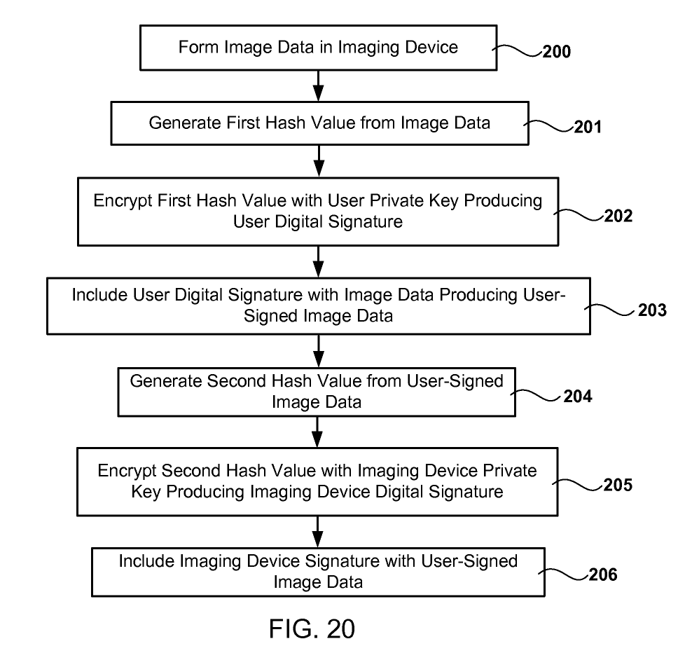

Some embodiments of the present invention may be described in relation to FIG. 20. In these embodiments, image data may be formed 200 in the imaging device 120. Exemplary methods by which the image data may be formed may comprise scanning a document at the imaging device, the process of receiving a fax, and the process of sending a fax. A first hash value, also considered a first message digest, may be generated 201 for the image data. Exemplary hashing algorithms comprise MD5, SHA-1, SHA-256 and other methods known in the art. The first hash value may be encrypted 202 using a private key associated with a user, thereby producing a user signature. The user digital signature may be included 203, for example by concatenation, with the digital image data, thereby producing user-signed document image. A second hash value may be generated 204 from the user-signed document image. The second hash value may be encrypted 205 using the private key securely stored on the imaging device 120, thereby generating a digital signature for the imaging device. The imaging device signature may be included 206, for example by concatenation, with the user-signed document image. In some embodiments of the present invention, the private key associated with the user may be securely stored on the imaging device 120. In alternative embodiments, the private key associated with the user may be securely stored remote to the imaging device 120.

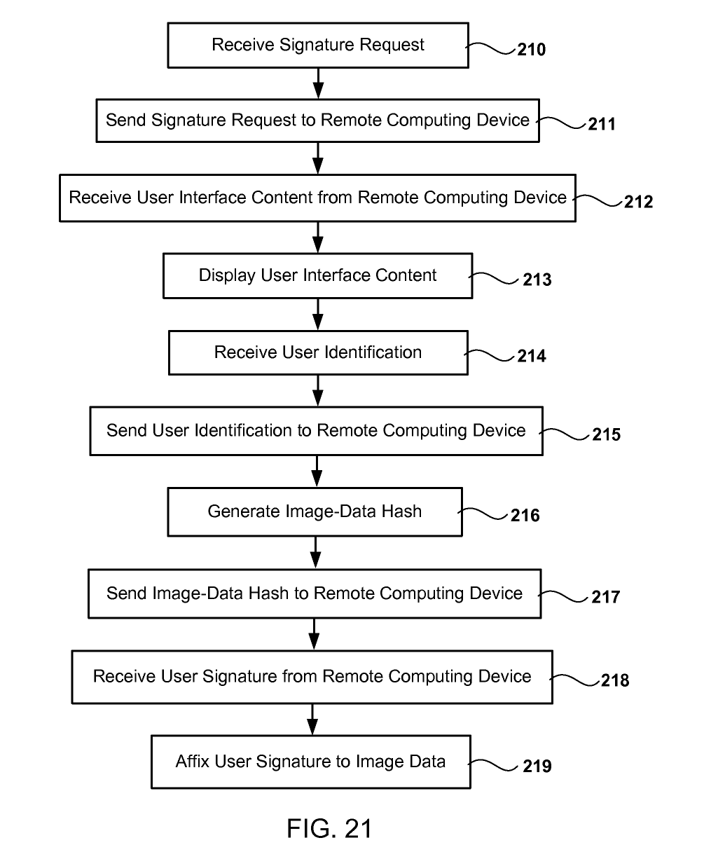

Some embodiments of the present invention may be described in relation to FIG. 21. In these embodiments, an imaging device 120 may be controlled by a remote computing device 129. The imaging device 120 may receive 210 a request through the user interface panel 121 or separate user interface 124 for a digital signature. The request may be sent 211 from the imaging device 120 to the remote computing device 129. The imaging device 120 may receive 212 from the remote computing device 129 user interface content, and the imaging device 120 may display 213 the user interface content on the display 123 of the user interface panel 121 or a display on the separate user interface 124. The user interface content may prompt a user for input of a user identification associated with the signature request. The imaging device 120 may receive 124 a user identification, and the imaging device 120 may send 215 the user identification to the remote computing device 129. The imaging device 120 may generate 216 a document hash for the document, also considered image data, to which a signature may be requested. The imaging device 120 may send 217 the document hash to the remote computing device 129. The imaging device 120 may receive 218 a digital signature associated with the identified user form the remote computing device 129. The imaging device may then affix 219 the user signature to the document, for example by concatenation.

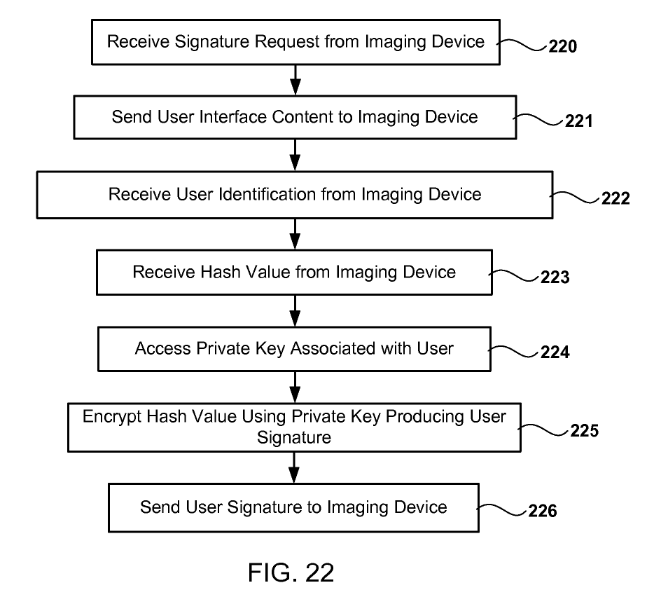

Some embodiments of the present invention may be described in relation to FIG. 22. In these embodiments, an imaging device 120 may be controlled by a remote computing device 129. A request for a digital signature may be received 220 from the imaging device 120 at the remote computing device 129. The remote computing device 129 may send 221 to the imaging device 120 user interface content. The user interface content may prompt a user at the imaging device 120 to input a user identification associated with the signature request. The remote computing device 129 may receive 222 from the imaging device 120 the user identification. The remote computing device 129 may receive 223 a hash value from the imaging device 120. The remote computing device 129 may access 224 a securely stored private key associated with the identified user, and the remote computing device 129 may encrypt 225 the hash value using the private key, thereby producing a user signature. The remote computing device 129 may send 226 the user signature to the imaging device 120 where, in some embodiments, the user signature may be affixed to the digital document.

In some embodiments of the present invention, a device-signed, user-signed or time-stamped image document, also considered image data, may be sent from the imaging device 120 to a remote server 130, for example a scan server or document server, where the image document may be sent to other remote computing devices or remote imaging devices. In some embodiments, the remote server 130 may check the signatures or time stamp, whichever may be present, using the appropriate public key before storing or allowing transfer of the document.

The terms and expressions which have been employed in the foregoing specification are used therein as terms of description and not of limitation, and there is no intention in the use of such terms and expressions of excluding equivalence of the features shown and described or portions thereof, it being recognized that the scope of the invention is defined and limited only by the claims which follow.

What is claimed is:

1. A method for providing authenticated digital information, said method comprising:
a) receiving a digital image at an imaging device, said imaging device comprising a first storage medium on which a private key associated with said imaging device resides;
b) generating a hash value for said digital image;
c) encrypting said hash value using said private key, thereby producing an encrypted hash value; and
d) associating said encrypted hash value with said digital image, thereby producing a signed digital image.

2. A method according to claim 1, wherein said imaging device is a multi-function peripheral.

3. A method according to claim 1, wherein said associating said encrypted hash value with said digital image comprises concatenating said encrypted hash value to said digital image.

4. A method according to claim 1 further comprising transmitting said signed digital image to a remote computing device.

5. A method according to claim 1 further comprising:
a) sending a user identifier from said imaging device to a remote computing device, said remote computing device comprising a second storage medium on which a private key associated with said user identifier resides;
b) sending said hash value to said remote computing device;
c) receiving a user digital signature from said remote computing device, wherein said user digital signature is associated with said user identifier; and
d) associating said user digital signature with said digital image.

6. A method according to claim 5, wherein said associating said user digital signature with said digital image comprises concatenating said user digital signature to said digital image.

7. A method according to claim 5, wherein said associating said user digital signature with said digital image comprises concatenating said user digital signature to said signed digital image.

8. A method according to claim 1 further comprising:
a) sending said hash value to a time-stamping authority;
b) receiving a time stamp from said time-stamping authority; and
c) associating said time stamp with said digital image.

9. A method according to claim 8, wherein said associating said time stamp with said digital image comprises concatenating said time stamp to said digital image.

10. A method according to claim 8, wherein said associating said time stamp with said digital image comprises concatenating said time stamp to said signed digital image.

11. A system for providing authenticated digital information, said system comprising:
a) a digital image receiver for receiving a digital image at an imaging device, said imaging device comprising a first storage medium on which a private key associated with said imaging device resides;
b) a hash value generator for generating a hash value for said digital image;
c) a hash value encoder for encrypting said hash value using said private key, thereby producing an encrypted hash value; and
d) a first affixer for associating said encrypted hash value with said digital image, thereby producing a signed digital image.

12. A system according to claim 11, wherein said imaging device is a multi-function peripheral.

13. A system according to claim 11, wherein said affixer for associating said encrypted hash value with said digital image comprises a concatenator for concatenating said encrypted hash value to said digital image.

14. A system according to claim 11 further comprising a transmitter for transmitting said signed digital image to a remote computing device.

15. A system according to claim 11 further comprising:
a) a user identification transmitter for sending a user identifier from said imaging device to a remote computing device, said remote computing device comprising a second storage medium on which a private key associated with said user identifier resides;
b) a hash-value transmitter for sending said hash value to said remote computing device;
c) a digital-signature receiver for receiving a user digital signature from said remote computing device, wherein said user digital signature is associated with said user identifier; and
d) a second affixer for associating said user digital signature with said digital image.

16. A system according to claim 11 further comprising:
a) a hash-value transmitter for sending said hash value to a time-stamping authority;
b) a time-stamp receiver for receiving a time stamp from said time-stamping authority; and
c) a time-stamp affixer for associating said time stamp with said digital image.

17. A method for providing authenticated digital information, said method comprising:
a) receiving a digital image at an imaging device;
b) generating a hash value for said digital image;
c) receiving a signature request at said imaging device;
d) transmitting said signature request to a remote computing device;
e) receiving display content at said imaging device from said remote computing device;
f) displaying said display content at said imaging device;
g) receiving a user identifier at said imaging device in response to said display content;
h) transmitting said user identifier to said remote computing device;
i) transmitting said hash value to said remote computing device;
j) receiving an encrypted hash value from said remote computing device, wherein said encrypted hash value was encrypted using a private key associated with said user identifier; and
k) associating said encrypted hash value with said digital image, thereby producing a user-signed digital image.

18. A method according to claim 17, wherein said imaging device is a multi-function peripheral.

19. A method according to claim 17, wherein said associating said encrypted hash value with said digital image comprises concatenating said encrypted hash value to said digital image.

20. A method according to claim 19 further comprising:
a) encrypting said hash value using a private key residing on said imaging device, thereby producing an device-encrypted hash value; and
b) associating said device-encrypted hash value with said digital image, thereby producing a device-signed digital image
